(19) United States
(12) Patent Application Publication
(10) Pub. No.: US 2024/0256879 A1
(43) Pub. Date: Aug. 1, 2024

(54) TRAINING A NEURAL NETWORK TO PERFORM AN ALGORITHMIC TASK USING A SELF-SUPERVISED LOSS

(71) Applicant: DeepMind Technologies Limited, London (GB)

(72) Inventors: Beatrice Bevilacqua, Lafayette, IN (US); Petar Velickovic, Cambridge (GB); Jovana Mitrovic, London (GB); Kyriacos Nikiforou, Strovolos (CY); Ioana Bica, London (GB); Borja Ibarz Gabardos, London (GB)

(21) Appl. No.: 18/423,239

(22) Filed: Jan. 25, 2024

Related U.S. Application Data
(60) Provisional application No. 63/481,777, filed on Jan. 26, 2023.

(51) Int. Cl. G06N 3/0895

(52) U.S. Cl. CPC G06N 3/0895

(57) ABSTRACT

Methods, systems, and apparatus, including computer programs encoded on a computer storage medium, for training a neural network to perform an algorithmic task. According to one aspect, there is provided a method comprising: obtaining an input dataset; generating a first augmented dataset and a second augmented dataset, wherein for both the first augmented dataset and the second augmented dataset: applying the computational algorithm to the augmented dataset causes the same computational operations to be performed at a target computational step as would be performed by applying the computational algorithm to the input dataset; processing the first augmented dataset and the second augmented dataset using the neural network, comprising, for each augmented dataset: generating an intermediate representation of the augmented dataset at an intermediate layer of the neural network; and training the neural network on an objective function, wherein the objective function comprises a self-supervised loss term.

### CROSS-REFERENCE TO RELATED APPLICATION

This application claims priority to U.S. Provisional Application No. 63/481,777, filed on Jan. 26, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can train a neural network to perform an algorithmic task (e.g., sorting a set of numbers, searching a data structure, determining a shortest path, etc.) using a self-supervised loss.

Throughout this specification, an “algorithmic task” can refer to any task that is solvable using an algorithm, e.g., a computational algorithm specified by a finite set of rules that, when applied to a dataset, cause the dataset to be processed over a sequence of computational steps to generate an algorithmic output.

Throughout this specification, a “machine learning task” can refer to any task that can be performed by a machine learning model, e.g., a neural network, as a result of being trained on a set of training data using a machine learning training technique.

The system described in this specification can train a neural network to perform an algorithmic task, and then train the neural network to perform a machine learning task (i.e., which is different than the original algorithmic task). That is, the system can pre-train the neural network to perform an algorithmic task and then fine-tune the neural network to perform a different machine learning task.

According to a first aspect, there is provided a method performed by one or more computers that includes training a neural network to perform an algorithmic task using a machine learning training technique. The algorithmic task is specified by a computational algorithm defined by a set of rules that, when applied to a dataset, cause the dataset to be processed over a sequence of computational steps to generate an algorithmic output. Training the neural network includes: obtaining an input dataset; generating a first augmented dataset and a second augmented dataset such that, for both the first augmented dataset and the second augmented dataset, applying the computational algorithm to the augmented dataset causes the same computational operations to be performed at a target computational step as would be performed by applying the computational algorithm to the input dataset; processing the first augmented dataset and the second augmented dataset using the neural network, by generating, for each augmented dataset, an intermediate representation of the augmented dataset at an intermediate layer of the neural network; and training the neural network on an objective function. The objective function includes a self-supervised loss term that depends on: (i) the intermediate representation of the first augmented dataset generated at the intermediate layer of the neural network, and (ii) the intermediate representation of the second augmented dataset generated at the intermediate layer of the neural network.

In some implementations, the training further includes processing a representation of the input dataset using the neural network to generate a predicted output at an output layer of the neural network and the objective function includes a supervised loss term that measures an error between: (i) the predicted output generated at the output layer of the neural network by processing the input dataset, and (ii) an algorithmic output generated by applying the computational algorithm to the input dataset.

In some implementations, the representation of the input dataset includes an input graph, the representation of the first augmented dataset includes a first augmented graph, and the representation of the second augmented dataset includes a second augmented graph.

In some implementations, the input graph is a sub-graph of the first augmented graph and the second augmented graph.

In some implementations, the input dataset includes an input set of data elements, the first augmented dataset includes a first augmented set of data elements, and the second augmented dataset includes a second augmented set of data elements such that the input set of data elements is a subset of the first augmented set of data elements and the second augmented set of data elements.

In some implementations, the input set of data elements is identical to the first augmented set of data elements, and the input set of data elements is a proper subset of the second augmented set of data elements.

In some implementations, the input set of data elements is a proper subset of both the first augmented set of data elements and the second augmented set of data elements.

In some implementations, the data elements are numerical values.

In some implementations, the self-supervised loss term measures a similarity between: (i) the intermediate representation of the first augmented dataset, and (ii) the intermediate representation of the second augmented dataset.

In some implementations, the intermediate representation of the first augmented dataset includes a respective embedding of each graph element in a set of graph elements of the first augmented graph and the intermediate representation of the second augmented dataset includes a respective embedding of each graph element in a set of graph elements of the second augmented graph.

In some implementations, the set of graph elements of the first augmented graph includes one or more nodes of the first augmented graph or one or more edges of the first augmented graph and the set of graph elements of the second augmented graph includes one or more nodes of the second augmented graph or one or more edges of the second augmented graph.

In some implementations, for each of one or more pairs of graph elements that include (i) a first graph element from the set of graph elements of the first augmented graph, and (ii) a second graph element of the set of graph elements of the second augmented graph, the self-supervised loss term measures a similarity between: (i) the embedding of the graph element in the intermediate representation of the first augmented dataset, and (ii) the embedding of a corresponding graph element in the intermediate representation of the second augmented dataset.

In some implementations, the self-supervised loss term measures a divergence between: (i) a first probability distribution over a subset of the graph elements of the first augmented graph, and (ii) a second probability distribution over a subset of the graph elements of the second augmented graph.

In some implementations, for each of a plurality of graph elements of the first augmented graph, the first probability distribution assigns a probability to the graph element that is based at least in part on the embedding of the graph element in the intermediate representation of the first augmented dataset and, for each of a plurality of graph elements of the second augmented graph, the second probability distribution assigns a probability to the graph element that is based at least in part on the embedding of the graph element in the intermediate representation of the second augmented dataset.

In some implementations, the divergence is a Kullback-Leibler divergence.

In some implementations, the algorithmic task is to sort a set of numerical values, or to search a set of numerical values, or to identify a strongly connected component of a graph.

In some implementations, the method further includes training the neural network to perform a machine learning task, after training the neural network to perform the algorithmic task.

In some implementations, the machine learning task is an image processing task, or a video processing task, or a text processing task, or an audio processing task, or a point cloud processing task.

In some implementations, the neural network has a graph neural network architecture.

In some implementations, the method further includes randomly sampling the target computational step from a sequence of computational steps required to process the input dataset using the computational algorithm.

In some implementations, the input dataset is a sequence of numerical values and generating the first augmented dataset or the second augmented dataset includes concatenating one or more new numerical values onto a terminal end of the input dataset.

According to another aspect, there is provided a method performed by one or more computers that includes processing an input dataset and generating a corresponding network output based on the input dataset using a neural network trained to perform an algorithmic task using the previous method.

According to another aspect, there is provided a system that includes one or more computers and one or more storage devices communicatively coupled to the one or more computers and storing instructions that, when executed by the one or more computers, cause the one or more computers to perform operations of the previous methods.

According to another aspect, there is provided one or more non-transitory computer storage media storing instructions that when executed by one or more computers cause the one or more computers to perform operations of the previous methods.

The subject matter described in this specification can be implemented in particular embodiments so as to realize one or more of the following advantages.

Training a neural network to perform an algorithmic task can enable the neural network to learn to implicitly reason in a manner that combines the robustness of algorithms with the flexibility of neural networks. After being trained to perform an algorithmic task, a neural network can be fine-tuned to perform a machine learning task (e.g., a machine learning task different from the algorithmic task). Pre-training the neural network to perform the algorithmic task can improve the performance (e.g., prediction accuracy) of the neural network on the machine learning task, and can reduce the amount of training data required to train the neural network to perform the machine learning task.

The system described in this specification can train a neural network to perform an algorithmic task using an objective function that includes a supervised loss term. For each input to the neural network, the supervised loss term encourages the neural network to generate a predicted output that matches an algorithmic output produced by a computational algorithm operating on the same input. Thus training the neural network using the supervised loss term encourages the neural network to reproduce the output of the computational algorithm. However, training the neural network to perform the algorithmic task using the supervised loss alone does not encourage the neural network to faithfully execute the internal logic of a computational algorithm, because the supervised loss relies on only the inputs to and outputs from the algorithm. Training a neural network using a supervised loss alone can therefore cause the neural network to learn slowly, e.g., requiring many training iterations to reach an acceptable prediction accuracy, and the trained neural network can be brittle, e.g., by failing to generalize to processing new inputs not seen in the training data.

To address this issue, the system described in this specification can train a neural network to perform an algorithmic task using an objective function that further includes a self-supervised loss term, i.e., in addition to the supervised loss term. The self-supervised loss term can be motivated by the observation that there can be many different inputs for which a computational algorithm will perform certain intermediate computations identically. The self-supervised loss term encourages the neural network to generate similar intermediate representations of inputs that result in identical (or similar) intermediate computations. Thus, in contrast to the supervised loss term, the self-supervised loss term leverages intermediate computational steps of an algorithm, in particular, to encourage the neural network to generate intermediate representations that are invariant across inputs having the same computational steps. Training the neural network using the self-supervised loss term can reduce the number of training iterations required to train the neural network, and thus reduce consumption of computational resources (e.g., memory and computing power) during training of the neural network. Further, training the neural network using the self-supervised loss term can improve the performance of the trained neural network, e.g., by enabling the trained neural network to gracefully generalize to new inputs not seen during training.

In some cases, the computational algorithm can require an input dataset to preprocessed in order to generate an accurate algorithmic output. The preprocessing can include, e.g., modifying the input dataset to be included in a predefined range, e.g., the range [0,1], or the range [0, ∞). Preprocessing large datasets can be computationally intensive. In contrast, the neural network may learn to robustly perform the algorithmic task without requiring preprocessing of the input data.

In some cases, the computational algorithm may be automatically extracted from traces specifying series of decisions taken (e.g., by a person or a computer) to accomplish one or more tasks (e.g., supply chain optimization). Training the neural network to emulate computational algorithms extracted from traces can enable the neural network to infer rules for performing similar tasks, without requiring additional training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a block diagram of an example neural network updated by an example update system.

FIG. 3 is a flow diagram of an example process for training a neural network to perform an algorithmic task.

FIG. 4 is a flow diagram of an example process for training a neural network to perform an algorithmic task using augmented data.

FIG. 5A and FIG. 5B illustrate example augmented datasets for algorithmic tasks.

Like reference numbers and designations in the various drawings indicate like elements.

### DETAILED DESCRIPTION

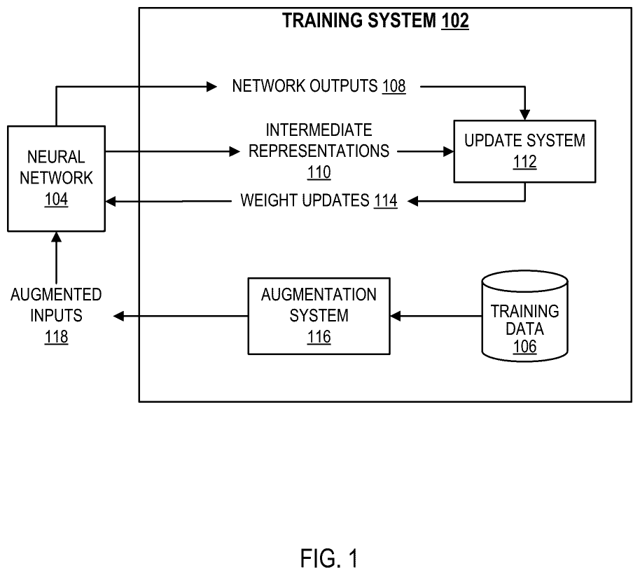

FIG. 1 shows an example training system 102. The training system 102 is an example of a system implemented as computer programs on one or more computers in one or more locations in which the systems, components, and techniques described below are implemented.

The training system 102 can train (e.g., pre-train) a neural network 104 to perform an algorithmic task.

The algorithmic task can be any task that is solvable using an algorithm, e.g., a computational algorithm specified by a finite set of rules that, when applied to a dataset, cause the dataset to be processed over a sequence of computational steps to generate an algorithmic output. The algorithmic task can be, e.g., sorting a set of numbers (e.g., using a bubble sort algorithm, a heapsort algorithm, an insertion sort algorithm, a quicksort algorithm, etc.), searching a data structure (e.g., using a bread-first or a depth-first algorithm to search a tree, or a binary search algorithm to search a set of numbers), determining a shortest path between two nodes in a graph such that the sum of the weights along the edges of the path is minimized (e.g., using Dijkstra's algorithm), etc.

In general, the algorithmic task can be to process an initial dataset and generate an output based on the initial dataset. The initial dataset can be any collection of data elements appropriate for the task. The initial dataset can be, e.g., a set, a list, a graph, etc., of data elements. As an example, the initial dataset can be a string of text. As another example, the initial dataset can be a collection of numerical values. For example, the initial dataset can be a list of numbers. As another example, the initial dataset can be a graph that has numerical values assigned to the graph nodes and edges.

For the algorithmic task, the output can be any appropriate output defined by applying the algorithm for the algorithmic task to an initial dataset. For example, when the algorithmic task is to sort a set of numbers, the output can be a sorted version of the initial dataset. As another example, when the algorithmic task is to search a data structure, the output can be a returned search result (e.g., a data element, a value assigned to a data element, an index of a data element, etc.). As another example, when the algorithmic task is to determine a shortest path between two nodes in a graph, the output can be a collection of graph nodes that define the shortest path, a length of the shortest path, and so on.

The algorithm for the algorithmic task can process an initial dataset over a sequence of computational steps. At each computational step, the algorithm can process an input dataset for the computational step to perform a computational operation to modify the input dataset for the computational step. The input dataset for a computational step can characterize an application of the algorithm to the initial dataset until the computational step. For example, when the algorithmic task is a sorting task, the input dataset for a computational step can characterize, e.g., a partially sorted version of the initial dataset, currently compared elements within the initial dataset, and so on. As another example, when the algorithmic task is to search a data structure, the input dataset for the computational step can characterize, e.g., previously visited elements of the data structure, currently visited elements of the data structure, and so on.

The computational operation at a computational step can characterize a transformation of the input dataset for the computational step. For example, when the algorithmic task is a sorting task, the computational operation at a given step can characterize swapping the indices of two data elements within the input dataset for the given step. As another example, when the algorithmic task is to search a graph, the computational operation at a given step can characterize assigning one node of the graph to be a parent of another node of the graph.

The neural network 104 is configured to perform the algorithmic task over a sequence of computational steps. At the each computational step, the neural network 104 can process a network input characterizing an input dataset for the computational step and can generate a network output 108 characterizing an application of a computational operation for the computational step. For example, the network output 108 can characterize an input dataset for a next computational step, as resulting from the application of the computational operation to the input dataset for the current computational step. As another example, the network output 108 can characterize a computational operation to be performed for the current computational step.

As part of generating the network output 108 for each computational step, the neural network 104 can generate an intermediate representation 110 of the input dataset for the computational step.

The training system 102 can train the neural network 104 to perform the algorithmic task using a set of training data 106. The training data 106 can include example applications of the algorithm for the algorithmic task to example initial datasets. In particular, the training data 106 can include example network inputs and target computational operations for sequences of computational steps as determined by applying the algorithm to the example initial datasets.

The neural network 104 can have any neural architecture suited to processing the network inputs that can characterize input datasets and generating network outputs characterizing computational operations for the algorithmic task. In some implementations, the network inputs can represent the input datasets as a graph that encodes information for the algorithmic task as node, edge, and graph features in the network input. The network output can be a graph output that encodes information characterizing a computational operation for a computational step of the algorithmic task as node, edge, and graph features in the network output.

In some implementations, the neural network 104 can be a graph neural network that can process graphs as network inputs to produce graphs as the network outputs. As a particular example, the network inputs and network outputs can have a graph encoding for the algorithmic task and the neural network 104 can be a message passing graph neural network as described by Velickovic et al., “The CLRS Algorithmic Reasoning Benchmark” (2022).

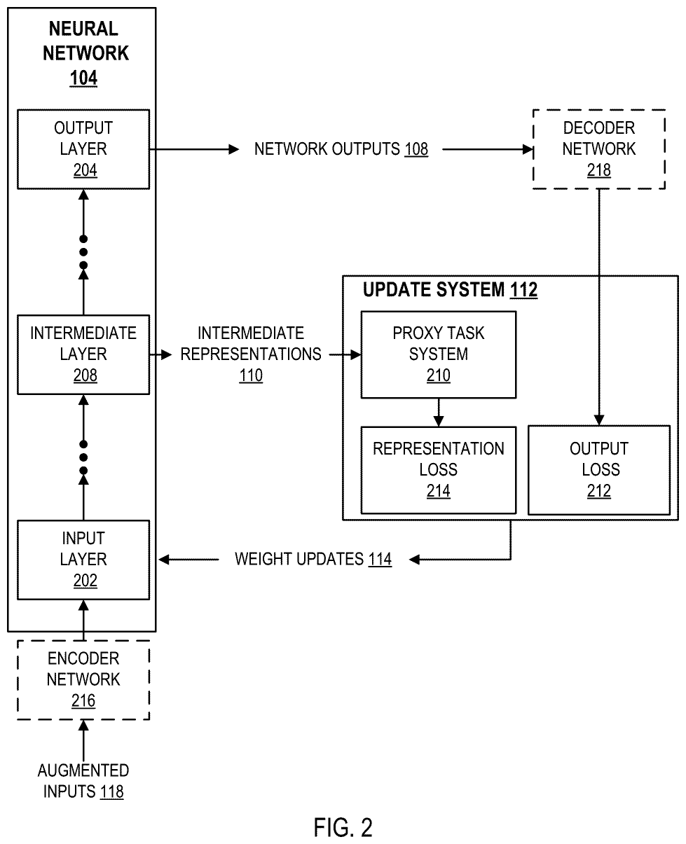

The neural network 104 is described in more detail below with reference to FIG. 2.

The training system 102 can include an update system 112. The update system 112 can process the network outputs 108 and intermediate representations 110 from the neural network 104 based on the training data 106. The update system 112 can produce weight updates 114 to train the neural network 104 to perform the algorithmic task. As an example, the training system 102 can determine weight updates 114 to train the neural network 104 to perform the algorithmic task by determining a gradient of an appropriate objective function (e.g., using stochastic gradient descent, RMSprop, Adam, etc.). In particular, the update system 112 can produce weight updates 114 that train the neural network 104 to generate network outputs 108 that characterize performing the same computational operations as applying the algorithm for the algorithmic task.

The training system 102 can include an augmentation system 116. As part of training the neural network 104 to perform the algorithmic task, the system 102 can use the augmentation system 116 to generate augmented network inputs 118 based on the training data 106. For any given computational step of the algorithm, the augmentation system 116 can generate augmented network inputs 118 that represent an augmented input dataset for the computational step. In particular, the augmentation system 116 can generate augmented network inputs 118 for each computational step of the algorithm that (i) represent an expanded dataset that has additional data elements compared to the un-augmented input dataset for the computational step and (ii) result in the same computational operations when processed by the algorithm as would be performed when processing the un-augmented input dataset using the algorithm.

The update system 112 can generate weight updates 114 that encourage the neural network 104 to produce intermediate representations 110 that are invariant to the augmentations gencrated by the augmentation system 116. The training system 102 can therefore train the neural network 104 such that, when a modification of an input dataset for a computational step does not change the operation performed by the algorithm for the algorithmic task, the same modification to the input dataset does not change the computational operation generated by the neural network 104.

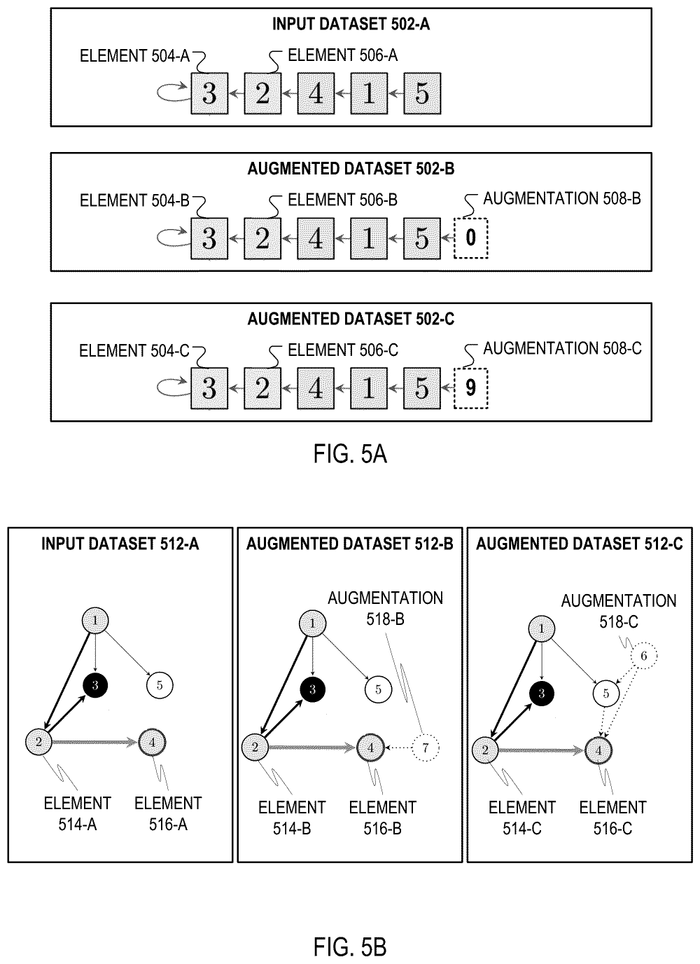

The update system 112 is described in more detail below with reference to FIG. 2. Example data augmentations for the algorithmic task are described in more detail below with reference to FIG. 5A and FIG. 5B.

The training system 102 can train (e.g., fine-tune) the neural network 104 to perform any appropriate machine learning task. In particular, the training system 102 can first pre-train the neural network 104 to perform the algorithmic task and can then fine-tune the neural network 104 to perform the machine learning task. In general, the machine learning task can be a different task than the algorithmic task. A few examples of machine learning tasks are described next.

In some implementations, the system 102 can train the neural network 104 to process a set of network inputs that represent the pixels of an image to generate a classification output that includes a respective score for each object category in a set of possible object categories (e.g., vehicle, pedestrian, bicyclist, etc.). The score for an object category can define a likelihood that the image depicts an object that belongs to the object category.

In some implementations, the system 102 can train the neural network 104 to process a set of network inputs that represent audio samples in an audio waveform to perform speech recognition, i.e., to generate an output that defines a sequence of phonemes, graphemes, characters, or words corresponding to the audio waveform.

In some implementations, the system 102 can train the neural network 104 to process a set of network inputs that represent words in a sequence of words to perform a natural language processing task, e.g., topic classification or summarization. To perform topic classification, the system 102 can train the neural network 104 to generate a network output that includes a respective score for each topic category in a set of possible category categories (e.g., sports, business, science, etc.). The score for a topic category can define a likelihood that the sequence of words pertains to the topic category. To perform summarization, the system 102 can train the neural network 104 to generate a network output that includes an output sequence of words that has a shorter length than the input sequence of words and that captures important or relevant information from the input sequence of words.

In some implementations, the system 102 can train the neural network 104 for a neural machine translation task, e.g., to process a set of network inputs that represent a sequence of text, e.g., a sequence of words, phrases, characters, or word pieces, in one language, to generate a network output that can be a translation of the sequence of text into another language, i.e., a sequence of text in the other language that is a translation of the input sequence of text. As a particular example, the task can be a multi-lingual machine translation task, where the neural network 104 is configured to translate between multiple different source language—target language pairs. In this example, the source language text can be augmented with an identifier that indicates the target language into which the neural network 104 should translate the source language text.

In some implementations, the system 102 can train the neural network 104 to perform an audio processing task. For example, if the network inputs represent a spoken utterance, then the output generated by the neural network 104 can be a score for each of a set of pieces of text, each score representing an estimated likelihood that the piece of text is the correct transcript for the utterance. As another example, if the network inputs represent a spoken utterance, the output generated by the neural network 104 can indicate whether a particular word or phrase (“hotword”) was spoken in the utterance. As another example, if the network inputs represent a spoken utterance, the output generated by the neural network 104 can identify the natural language in which the utterance was spoken.

In some implementations, the system 102 can train the neural network 104 to perform a natural language processing or understanding task, e.g., an entailment task, a paraphrase task, a textual similarity task, a sentiment task, a sentence completion task, a grammaticality task, and so on, that operates on a set of network inputs representing text in some natural language.

In some implementations, the system 102 can train the neural network 104 to perform a text to speech task, where the network inputs represent text in a natural language or features of text in a natural language and the network output is a spectrogram, a waveform, or other data defining audio of the text being spoken in the natural language.

In some implementations, the system 102 can train the neural network 104 to perform a health prediction task, where the network inputs represent data derived from data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, the system 102 can train the neural network 104 to perform a text generation task, where the network inputs represent a sequence of text, and the output is another sequence of text, e.g., a completion of the input sequence of text, a response to a question posed in the input sequence, or a sequence of text that is about a topic specified by the first sequence of text. As another example, the network inputs can represent data other than text, e.g., an image, and the output sequence can be text that describes the data represented by the network inputs.

In some implementations, the system 102 can train the neural network 104 to perform an image generation task, where the network inputs represent a conditioning input and the output is a sequence of intensity value inputs for the pixels of an image.

In some implementations, the system 102 can train the neural network 104 to perform an agent control task, where the network inputs represent a sequence of one or more observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

In some implementations, the system 102 can train the neural network 104 to perform a genomics task, where the network inputs represent a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some implementations, the system 102 can train the neural network 104 to perform a protein modeling task, e.g., where the network inputs represent a protein and the network output characterizes the protein. For example, the network output can characterize a predicted stability of the protein or a predicted structure of the protein.

In some implementations, the system 102 can train the neural network 104 to perform a point cloud processing task, e.g., where the network inputs represent a point cloud (e.g., generated by a lidar or radar sensor) and the network output characterizes, e.g., a type of object represented by the point cloud.

In some implementations, the system 102 can train the neural network 104 to perform a combination of multiple individual machine learning tasks, e.g., two or more of the machine learning tasks mentioned above. For example, the neural network 104 can be configured to perform multiple individual natural language understanding tasks, with the network inputs processed by the neural network 104 including an identifier for the individual natural language understanding task to be performed on network inputs.

The training data 106 can include training data for the machine learning task. As an example, when the machine learning task is a classification or a prediction task, the training data 106 can include example network inputs and corresponding target network outputs. As another example, when the machine learning task is a generation task, the training data 106 can include example network inputs and example desired network outputs.

The training system 102 can train the neural network 104 to perform the machine learning task based on the training data 106 using any appropriate machine learning technique for the machine learning task. As an example, the training system 102 can determine weight updates 114 to train the neural network 104 to perform the machine learning task by determining a gradient of an appropriate objective function for the machine learning task. For example, when the machine learning task is a prediction task, the system 102 can train the neural network 104 by optimizing a prediction error (e.g., mean squared error) between the network outputs 108 and corresponding target outputs from the training data 106. As another example, when the machine learning task is a classification task, the system 102 can train the neural network 104 by optimizing a classification objective function (e.g., cross-entropy loss) between the network outputs 108 and corresponding target outputs from the training data 106. As another example, when the machine learning task is a generation task, the system 102 can train the neural network 104 by optimizing a generative objective function (e.g., Kullback-Leibler divergence) between a distribution for the network outputs 108 and a corresponding distribution for the target outputs from the training data 106.

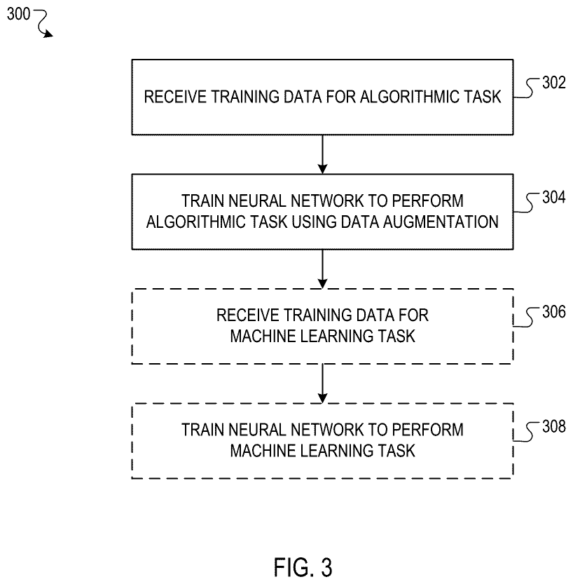

An example process for pre-training the neural network 104 to perform the algorithmic task and fine-tuning the neural network 104 to perform the machine learning task is described in more detail below with reference to FIG. 3.

FIG. 2 is a block diagram of an example neural network 104 updated by an example update system 112.

As described above, the neural network 104 can process network inputs and generate corresponding network outputs 108 for the algorithmic task. The neural network 104 can include multiple processing network layers. For example, the network 104 can include an input layer 202 that can process the network inputs and an output layer 204 that can generate the network outputs 108.

The network inputs can be augmented inputs 118 based on corresponding input datasets. Each augmented input 118 can represent a modification of an input dataset for the augmented input that both (i) adds one or more data elements to the input dataset and (ii) results in the algorithm for the algorithmic task performing the same computational operations as for input data set for the next computational step.

The neural network 104 can have any architecture suitable for performing the algorithmic task. As described above, the neural network 104 can be a graph neural network and can process and generate graph representations of the algorithmic task. The neural network 104 can include any of a variety of architectures suited to processing sequential data. For example, the neural network 104 can include recurrent architectures (e.g., recurrent neural networks, LSTM networks, etc.) and can process and update an internal state for the network 104 that characterizes a performed sequence of computational steps. As another example, the neural network can include attention based architectures (e.g., Transformer networks) and can process network inputs that characterize a performed sequence of computational steps.

As part of training the neural network 104, the training system 102 can train an optional encoder network 216 and an optional decoder network 218. The encoder network 216 can process input data for the machine learning task and generate network inputs that the neural network 104 can use to select computational operations. The decoder network 218 can process network outputs from the neural network 104 and can generate corresponding outputs for the machine learning task (e.g., outputs corresponding to performing a computational operation selected by the neural network 104 to the input data for the machine learning task).

The neural network 104, encoder network 216, and decoder network 218 can have any appropriate architecture suitable for performing the machine learning task. For example, if the machine learning task is an image processing task, the neural network 104, encoder network 216, and decoder network 218 can architectures suited to processing image data (e.g., convolutional neural networks, visual Transformers, etc.). As another example, if the machine learning task is a text processing task, the neural network 104, encoder network 216, and decoder network 218 can architectures suited to processing sequential data (e.g., recurrent neural networks, Transformers, etc.).

As described above, the update system 112 can process intermediate representations 110 from an intermediate layer 208 and the network outputs 108 to determine weight updates 114 for the neural network 104. The intermediate representations 110 can be outputs from any intermediate layer 208 of the neural network 104. For example, the intermediate representations can be outputs from a pre-determined intermediate layer 208 of the neural network 104. To train the neural network 104 to perform the algorithmic task, the update system 112 can determine the weight updates 114 based on an objective function for the algorithmic task.

The objective function for the algorithmic task can include an output loss 212 based on the network outputs 108. In particular, for a given input dataset within the training data, the output loss 212 for the algorithmic task can be a supervised loss term that measures an error between: (i) the network output 108 generated by the neural network 104 processing the given input dataset, and (ii) an algorithmic output generated by applying the algorithm to the input dataset. As an example, if the algorithm involves selecting a computational operation to perform, the supervised loss term for the algorithmic task can include a cross-entropy loss calculated between the network outputs and the target outputs from the algorithm. As another example, if the algorithm involves calculating a given value, the supervised loss term for the algorithmic task can include a prediction error (e.g., mean squared error) between the given value as calculated by the neural network 104 and as calculated by the algorithm.

The objective function can for the algorithmic task can include a representation loss 214 based on the intermediate representations 110. The representation loss 214 can be a self-supervised loss term that determines, for each input dataset, a similarity among multiple intermediate representations generated by the neural network 104 processing different augmentations of the input dataset.

When the network inputs represent the input dataset as a graph, the intermediate representations can be graphs. In particular, the intermediate representations can be graphs that include multiple graph elements (e.g., nodes, edges, sub-graphs, the entire graph etc.) and associate embeddings to each of the graph elements. The self-supervised loss term can determine the similarity among intermediate representations by measuring similarities between the embeddings of corresponding graph elements within the intermediate representations.

The representation loss 214 can be based on an effectiveness of the intermediate representations 110 for use in performing a proxy task. The proxy task can be any of a variety of processing tasks to produce outputs that, for each input dataset, remain unchanged for all augmentations of the input dataset. For example, the proxy task can be a classification task to assign classifications for graph elements characterized by the intermediate representations. As another example, the proxy task can be an instance classification task to assign unique (with regard to a training set) identifying indices for graph elements characterized by the intermediate representations. In general, the proxy task can be a refinement of the algorithmic task, such that the computational operations of the algorithmic task can be determined based on the results of the proxy task alone. The proxy task can therefore be to directly generate classifications that determine the computational operations of the algorithmic task.

In some implementations, the system can train the neural network 104 to perform the algorithmic task by first training the neural network 104 to generate intermediate representations to perform the proxy task using the representation loss 214 and by then training the neural network 104 to perform the algorithmic task using both the representation loss 214 and the output loss 212.

The update system 112 can include a proxy task system 210. The proxy task system 210 can process the intermediate representations 110 to perform the proxy task. The proxy task system 210 can be a proxy task neural network that the update system can train (e.g., based on the representation loss 214 and alongside the neural network 104) to perform the proxy task.

The semi-supervised loss can include any of a variety of terms that can, when optimized, encourage the intermediate representations to be unchanged by augmentations of the input datasets. In particular, the semi-supervised loss can include terms that are minimized only when the intermediate representations are invariant to the augmentations of the input datasets.

As an example, the semi-supervised loss can include a similarity term that evaluates the similarity of intermediate representations by determining pair-wise similarities between intermediate representations. For example, when the proxy task is to assign a set of N classification outputs, yᵢ(\tilde{x}) for i between 1 and N, to each graph element \tilde{x} from an intermediate representation \tilde{X} of an input dataset X, the similarity term can be determined following:

$${ℒ}_{s i m} = {\sum }_{\tilde{x} ∈ \tilde{X}} {\sum }_{a , b ∈ A} {\sum }_{i = 1}^{N} \frac{{e}^{ϕ ( {\tilde{x}}^{[ a ]} , i ; {\tilde{x}}^{[ b ]} , i )}}{{\sum }_{( \tilde{z} , j ) ∈ C ( \tilde{x} , i )} {e}^{ϕ ( {\tilde{x}}^{[ a ]} , i ; {\tilde{z}}^{[ b ]} , j )}}$$

Where A is a set of augmentations for the input dataset, X, ϕ is a comparison function, C(\tilde{x}, i) is a contrastive set for element \tilde{x} and classification output yᵢ(\tilde{x}), and \tilde{x}^{[a]} represents the graph embedding obtained for \tilde{x} when the augmentation a is applied to the input dataset. The comparison function, ϕ, can be any appropriate function that produces a scalar value comparing graph elements of the intermediate representations. As an example, the comparison function, ϕ, can be determined following:

$$ϕ ( {\tilde{x}}^{[ a ]} , i ; {\tilde{z}}^{[ b ]} , j ) = < {h}_{i} ( {\tilde{x}}^{[ a ]} ) , {h}_{j} ( {\tilde{z}}^{[ b ]} ) >$$

Where <·,·> is an inner product (e.g., a vector dot product) and h is a neural network (e.g., the proxy task neural network of the proxy task system 210.

As an example, the comparison function, ϕ, can be determined following:

$$ϕ ( {\tilde{x}}^{[ a ]} , i ; {\tilde{z}}^{[ b ]} , j ) = - {\vert \vert {h}_{i} ( {\tilde{x}}^{[ a ]} ) - {h}_{j} ( {\tilde{z}}^{[ b ]} ) \vert \vert}^{2}$$

The contrastive set C(\tilde{x}, i) can include a variety of contrastive elements for the pair (\tilde{x}, yᵢ(\tilde{x})). For example, the contrastive set C(\tilde{x}, i) can include any graph element, \tilde{z}, different from \tilde{x}. As another example, the contrastive set C(\tilde{x}, i) can include any classification outputs, yⱼ, where j≠i.

In some implementations, the system can evaluate the similarity term following:

$${ℒ}_{s i m} = {\sum }_{\tilde{x} ∈ \tilde{X}} {\sum }_{b ∈ A} {\sum }_{i = 1}^{N} \frac{{e}^{ϕ ( \tilde{x} , i ; {\tilde{x}}^{[ b ]} , i )}}{{\sum }_{( \tilde{z} , j ) ∈ C ( \tilde{x} , i )} {e}^{ϕ ( \tilde{x} , i ; {\tilde{z}}^{[ b ]} , j )}}$$

Namely, the system can determine similarities between the intermediate representation for the input dataset and intermediate representations of augmentations of the input dataset.

As another example, the semi-supervised loss can include a divergence term that evaluates a similarity of probability distributions determined based on the intermediate representations. In particular, the divergence term can be a Kullback-Liebler divergence term determined following:

$${ℒ}_{div} = {\sum }_{\tilde{x} ∈ \tilde{X}} {\sum }_{a , b , c , d ∈ A} {D}_{KL} ( p ( y ( {\tilde{x}}^{[ a ]} ) \vert y ( {\tilde{x}}^{[ b ]} ) ) \vert \vert p ( y ( {\tilde{x}}^{[ c ]} ) \vert y ( {\tilde{x}}^{[ d ]} ) ) )$$

Where p(y(\tilde{x}^{[a]})|y(\tilde{x}^{[b]})) is a conditional probability of assigning classification output y(\tilde{x}^{[a]}) when processing element \tilde{x}^{[a]} given the assignment of classification output y(˜[b]) when processing element \tilde{x}^{[b]}. The system can determine the conditional probability following:

$$p ( y ( {\tilde{x}}^{[ a ]} ) = i \vert y ( {\tilde{x}}^{[ b ]} ) = j ) ∝ {e}^{ϕ ( {\tilde{x}}^{[ a ]} , i ; {\tilde{x}}^{[ b ]} , j )}$$

The semi-supervised loss can be a combination of terms that can, when optimized, encourage the intermediate representations to be unchanged by augmentations of the input datasets. For example, the semi-supervised loss can be:

$$ℒ = {ℒ}_{sim} + α {ℒ}_{div}$$

Where [symbol] ₛᵢₘ is the similarity term described above, [symbol] _{div} is the divergence term described above, and α>0 is a scaling term.

The self-supervised loss term as described above encourages the neural network 104 to generate similar intermediate representations of input datasets that result in identical (or similar) computational operations. The self-supervised loss term therefore leverages intermediate computational steps of an algorithm, in particular, to encourage the neural network 104 to generate intermediate representations that are invariant across inputs that have the same computational steps as processed by the algorithm.

To train the neural network 104 to perform the machine learning task, the update system 112 can determine the weight updates 114 based on an objective function for the machine learning task. The objective function for the machine learning task can include an output loss 212 for the machine learning task based on the network outputs 108 generated by the neural network 104 when processing input data for the machine learning task.

FIG. 3 is a flow diagram of an example process for training a neural network to perform an algorithmic task. For convenience, the process 300 will be described as being performed by a system of one or more computers located in one or more locations. For example, a training system, e.g., the training system 102 of FIG. 1, appropriately programmed in accordance with this specification, can perform the process 300.

The system can receive training data for the algorithmic task (step 302). The algorithmic task can be any task that is solvable using an algorithm, e.g., a computational algorithm specified by a finite set of rules that, when applied to a dataset, cause the dataset to be processed over a sequence of computational steps to generate an algorithmic output. The algorithmic task can be, e.g., to sort a set of numerical values, to search a set of numerical values, to identify a strongly connected component of a graph, etc. The training data for the algorithmic task can specify example applications of the algorithm to example initial datasets. For example, the training data can include, for each example initial dataset, an input dataset and a desired computational operation for a sequence of computational steps determined by applying the algorithm to the example initial dataset.

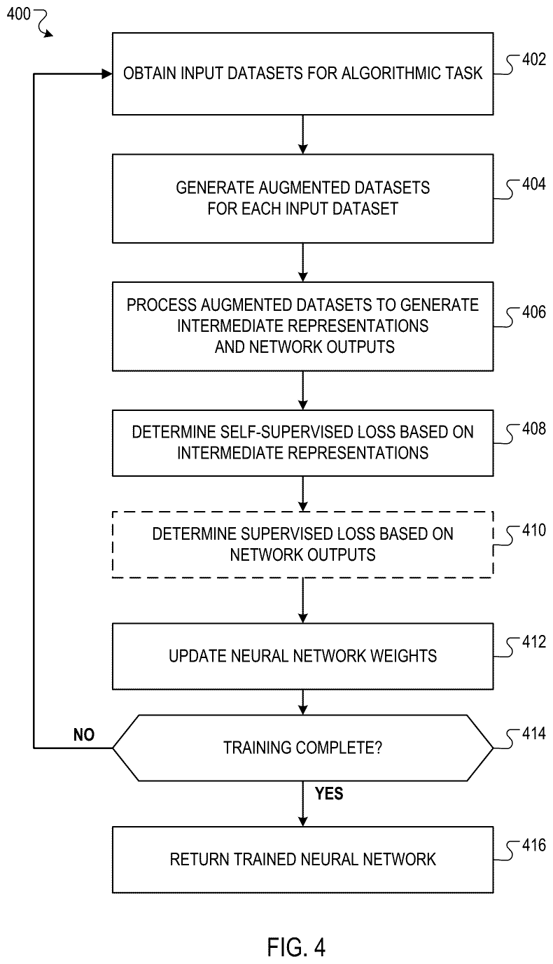

The system can train (e.g., pre-train) the neural network to perform the algorithmic task using data augmentation (step 304). The system can generate an augmentation for an input dataset at given computational step in the training data that adds one or more data elements to the input dataset without altering the computational operation that will be performed by the algorithm at the computational step. By using the data augmentation, the system can train the neural network to perform the algorithmic task while encouraging an invariance of the neural network to the above described augmentations. An example process for training the neural network to perform the algorithmic task using data augmentation is described in further detail below with reference to FIG. 4.

In some implementations, the system can receive training data for a machine learning task (e.g., a machine learning task different from the algorithmic task) (step 306). The machine learning task can be, for example, an image processing task, or a video processing task, or a text processing task, or an audio processing task, a point cloud processing task, and so on. The training data for the machine learning task can be any appropriate data specifying example network inputs (e.g., data characterizing input images, video, text, audio, point clouds, etc.) and desired network outputs.

In some implementations, the system can train (e.g., fine-tune) the neural network to perform the machine learning task (step 308). In particular, the system can train the neural network by optimizing an objective function for the machine learning task that encourages the neural network to produce the desired network outputs when processing the example network inputs from the training data for the machine learning task.

FIG. 4 is a flow diagram of an example process for training a neural network to perform an algorithmic task using augmented data. For convenience, the process 400 will be described as being performed by a system of one or more computers located in one or more locations. For example, a training system, e.g., the training system 102 of FIG. 1, appropriately programmed in accordance with this specification, can perform the process 400.

The system can train the neural network to perform the algorithmic task over a sequence of update iterations using training data for the algorithmic task. The training data for the algorithmic task can example input datasets and corresponding target computational operations as determined at computational steps of applying a computational algorithm to an initial dataset.

At each update iteration, the system can obtain input datasets for the algorithmic task (step 402). The system can obtain input datasets from any computational step of the application of the computational algorithm to initial datasets from the training data. In some implementations, the input datasets can be initial datasets for applications of the algorithm.

For each input dataset, the system can generate augmented datasets for the task (step 404). The system can generate the augmented datasets such that applying the computational algorithm to the augmented dataset causes the same computational operations to be performed at a target computational step as would be performed by applying the computational algorithm to the input dataset. As an example, the system can generate the augmented datasets such that the computational algorithm will perform the same computational operations for the augmented datasets as for the corresponding un-augmented input datasets. As another example, the system can generate the augmented datasets such that applying the computational algorithm to the augmented datasets causes the same computational operations to be performed during a range of computational steps (e.g., up to and including the target computational step) as would be performed by applying the computational algorithm to the input dataset.

In some implementations, the system can select the target computational step. As an example, the system can randomly sample the target computational step from a sequence of computational steps required to process the input dataset using the computational algorithm.

In some implementations, the input dataset can be a sequence of numerical values and the system can generate the augmented datasets by concatenating one or more new numerical values onto a terminal end of the input dataset.

In some implementations, the system can generate pairs of augmented datasets for the task.

The input dataset can be an input set of data elements and system can generate the augmented datasets as augmented sets of data elements. In some implementations, the system can generate the augmented datasets for each input dataset such that the input set of data elements for the dataset is a subset of the corresponding augmented sets of data elements. As an example, when the system generates pairs of augmented datasets, the first augmented set of data elements of the pair can be identical to the corresponding input set of data elements and can be a proper subset of second augmented set of data elements of the pair. As another example, when the system generates pairs of augmented datasets, the input set of data elements can be a proper subset of both the first augmented set of data elements and the second augmented set of data elements for the pair.

Example data augmentations for the algorithmic task are described in more detail below with reference to FIG. 5A and FIG. 5B.

The system can process the augmented datasets using the neural network to generate corresponding intermediate representations and network outputs (step 406).

In some implementations, the neural network can be a graph neural network. For each input dataset, the input dataset can be represented by an input graph and the augmented datasets of the pair of augmented datasets can be represented by corresponding augmented graphs. In particular, when the system generates pairs of augmented datasets, the input graph can be a sub-graph of the first augmented graph and of the second augmented graph. The intermediate representations of the datasets of the pair can be respective embeddings of each graph element in a set of graph elements (e.g., nodes, edges, etc.) of the respective augmented graphs.

The system can determine a self-supervised loss for the update iteration based on the intermediate representations (step 408). As described above, the self-supervised loss can measure similarities between the intermediate representations. As an example, when the intermediate representations are graph representations, the self-supervised loss can measure a similarity of the embeddings for corresponding graph elements of the intermediate representations.

As part of determining the self-supervised loss for the update, the system can evaluate a utility of the intermediate representations for performing a proxy task. The proxy task can be a classification task, such as assigning classifications or unique labels to graph elements of the intermediate representation.

In some implementations, the self-supervised loss can also measure a divergence (e.g., a Kullback-Liebler divergence) between probability distributions determined by the intermediate representations for each input dataset. For example, when the intermediate representations are graph representations, the self-supervised loss can also measure a divergence between pairs of probability distributions over the graph elements of the intermediate representations. As a further example, when the system evaluates the utility of the intermediate representations for performing the proxy task, the self-supervised loss can measure a divergence between conditional distributions for classification probabilities over the graph elements.

In some implementations, the system can determine a supervised loss for the update iteration based on the network outputs (step 410). The supervised loss can measure, for each input dataset, an error between the neural network output and a target algorithmic output when processing the input dataset. In general, the supervised loss can encourage the neural network to perform the same computational operations as the algorithm for the algorithmic task when processing the input datasets from the training data.

The system can update the weights of the neural network based on the losses for the update iteration (step 412). In particular, the system can determine weight updates for the neural network by optimizing an objective function based on the self-supervised and supervised losses for the input datasets.

The system can determine whether the training has completed (step 414). The system can determine whether the training has completed based on any suitable criterion. For example, the system can determine that training has completed after a pre-determined number of update iterations. As another example, the system can determine that training has completed based on the losses determined for the update iteration. As a particular example, the system can determine that training has completed based on whether the losses for the update iteration attain pre-determined threshold values. As another particular example, the system can determine that training has completed based on a difference between the losses determined for the current update iteration and a previous update iteration (e.g., based on whether the difference indicates a convergence of the neural network).

If the system determines that training has not completed, the system can proceed to a next update iteration for training the neural network.

When the system determines that the training has completed, the system can return the trained neural network (step 416).

FIG. 5A and FIG. 5B illustrates example augmented datasets for algorithmic tasks.

As described above, a training system (e.g., the training system 102 of FIG. 1) can generate augmented datasets for the computational steps of an algorithmic task. The system can generate the augmented datasets by adding data elements to an initial dataset that do not change the computational operations that will be performed by an algorithm for the algorithmic task. The following describes example augmented datasets that may the training system may generate for some example algorithmic tasks.

FIG. 5A illustrates example augmented datasets 502-B and 502-C based on an input dataset 502-A for the algorithmic task of sorting a list of numerical values using bubble-sort. The input dataset 502-A corresponds to an input for a first computational step in sorting the list [3,2,4,1,5]. Following the bubble-sort algorithm, the first computational operation is to swap elements 504-A and 506-A (e.g., to swap the “3” and the “2” to yield the list [2,3,4,1,5]).

The augmented datasets 502-B and 502-C are generated by adding augmenting data elements 508-B and 508-C that do not result in changing the resulting computational operation. Namely, the augmentation 508-B is chosen so that the first computational step in processing the dataset 502-B is to swap the elements 504-B and 506-B and the augmentation 508-C is chosen so that the first computational step in processing the dataset 502-C is to swap the elements 504-C and 506-C. The datasets 502-B and 502-C are valid augmentations of the input dataset 502-A because the first steps for sorting the lists [2,3,4,1,5,0] and [2,3,4,1,5,9] using bubble sort are the same as for sorting the list [2,3,4,1,5] (e.g., swapping the “3” and the “2”).

FIG. 5B illustrates example augmented datasets 512-B and 512-C based on an input dataset 512-A for the algorithmic task of performing a depth-first search of a graph. The input dataset 512-A corresponds to an input for a computational step in the depth-first search of visiting element 516-A from element 514-A (e.g., to visit node “4” from node “2”, after having visited node “2” from node “1” and then node “3” from node “2”).

The augmented datasets 512-B and 512-C are generated by adding augmenting data elements 518-B and 518-C that do not result in changing the resulting computational operation. Namely, the augmentation 518-B is chosen so that the first computational step in processing the dataset 512-B is to element 516-B from element 514-B and the augmentation 518-C is chosen so that the first computational step in processing the dataset 512-C is to element 516-C from element 514-C. The datasets 512-B and 512-C are valid augmentations of the input dataset 512-A because the next computational step remains visiting node “4” from node “2”, regardless of the additions of node “7” to dataset 512-B and node “6” to dataset 512-C.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
training a neural network to perform an algorithmic task using a machine learning training technique,
wherein the algorithmic task is specified by a computational algorithm defined by a set of rules that, when applied to a dataset, cause the dataset to be processed over a sequence of computational steps to generate an algorithmic output, and
wherein training the neural network comprises:
obtaining an input dataset;
generating a first augmented dataset and a second augmented dataset, wherein for both the first augmented dataset and the second augmented dataset:
applying the computational algorithm to the augmented dataset causes the same computational operations to be performed at a target computational step as would be performed by applying the computational algorithm to the input dataset;
processing the first augmented dataset and the second augmented dataset using the neural network, comprising, for each augmented dataset:
generating an intermediate representation of the augmented dataset at an intermediate layer of the neural network; and
training the neural network on an objective function, wherein the objective function comprises a self-supervised loss term that depends on: (i) the intermediate representation of the first augmented dataset generated at the intermediate layer of the neural network, and (ii) the intermediate representation of the second augmented dataset generated at the intermediate layer of the neural network.

2. The method of claim 1, wherein the training further comprises:
processing a representation of the input dataset using the neural network to generate a predicted output at an output layer of the neural network; and
wherein the objective function comprises a supervised loss term that measures an error between: (i) the predicted output generated at the output layer of the neural network by processing the input dataset, and (ii) an algorithmic output generated by applying the computational algorithm to the input dataset.

3. The method of claim 1, wherein the representation of the input dataset comprises an input graph, the representation of the first augmented dataset comprises a first augmented graph, and the representation of the second augmented dataset comprises a second augmented graph.

4. The method of claim 3, wherein the input graph is a sub-graph of the first augmented graph and the second augmented graph.

5. The method of claim 1, wherein the input dataset comprises an input set of data elements, the first augmented dataset comprises a first augmented set of data elements, and the second augmented dataset comprises a second augmented set of data elements;
wherein the input set of data elements is a subset of the first augmented set of data elements and the second augmented set of data elements.

6. The method of claim 5, wherein the data elements are numerical values.

7. The method of claim 2, wherein the self-supervised loss term measures a similarity between: (i) the intermediate representation of the first augmented dataset, and (ii) the intermediate representation of the second augmented dataset.

8. The method of claim 7, wherein the intermediate representation of the first augmented dataset comprises a respective embedding of each graph element in a set of graph elements of the first augmented graph; and
wherein the intermediate representation of the second augmented dataset comprises a respective embedding of each graph element in a set of graph elements of the second augmented graph.

9. The method of claim 8, wherein the set of graph elements of the first augmented graph comprises one or more nodes of the first augmented graph or one or more edges of the first augmented graph; and
wherein the set of graph elements of the second augmented graph comprises one or more nodes of the second augmented graph or one or more edges of the second augmented graph.

10. The method of claim 9, wherein for each of one or more pairs of graph elements comprising: (i) a first graph element from the set of graph elements of the first augmented graph, and (ii) a second graph element of the set of graph elements of the second augmented graph:
the self-supervised loss term measures a similarity between: (i) the embedding of the graph element in the intermediate representation of the first augmented dataset, and (ii) the embedding of a corresponding graph element in the intermediate representation of the second augmented dataset.

11. The method of claim 9, wherein the self-supervised loss term measures a divergence between: (i) a first probability distribution over a subset of the graph elements of the first augmented graph, and (ii) a second probability distribution over a subset of the graph elements of the second augmented graph.

12. The method of claim 11, wherein for each of a plurality of graph elements of the first augmented graph, the first probability distribution assigns a probability to the graph element that is based at least in part on the embedding of the graph element in the intermediate representation of the first augmented dataset; and
wherein for each of a plurality of graph elements of the second augmented graph, the second probability distribution assigns a probability to the graph element that is based at least in part on the embedding of the graph element in the intermediate representation of the second augmented dataset.

13. The method of claim 11, wherein the divergence comprises a Kullback-Leibler divergence.

14. The method of claim 1, wherein the algorithmic task comprises sorting a set of numerical values, or searching a set of numerical values, or identifying a strongly connected component of a graph.

15. The method of claim 1, further comprising, after training the neural network to perform the algorithmic task:
training the neural network to perform a machine learning task.

16. The method of claim 15, wherein the machine learning task comprises an image processing task, or a video processing task, or a text processing task, or an audio processing task, or a point cloud processing task.

17. The method of claim 1, wherein the neural network has a graph neural network architecture.

18. A method performed by one or more computers, the method comprising:
processing an input dataset using a neural network trained, using a machine learning technique, to perform an algorithmic task;
wherein the algorithmic task is specified by a computational algorithm defined by a set of rules that, when applied to a dataset, cause the dataset to be processed over a sequence of computational steps to generate an algorithmic output, and
wherein training the neural network comprises:
obtaining an input dataset;
generating a first augmented dataset and a second augmented dataset, wherein for both the first augmented dataset and the second augmented dataset:
applying the computational algorithm to the augmented dataset causes the same computational operations to be performed at a target computational step as would be performed by applying the computational algorithm to the input dataset;
processing the first augmented dataset and the second augmented dataset using the neural network, comprising, for each augmented dataset:
generating an intermediate representation of the augmented dataset at an intermediate layer of the neural network; and
training the neural network on an objective function, wherein the objective function comprises a self-supervised loss term that depends on: (i) the intermediate representation of the first augmented dataset generated at the intermediate layer of the neural network, and (ii) the intermediate representation of the second augmented dataset generated at the intermediate layer of the neural network.

19. A system comprising:
one or more computers; and
one or more storage devices communicatively coupled to the one or more computers, wherein the one or more storage devices store instructions that, when executed by the one or more computers, cause the one or more computers to perform operations comprising:
training a neural network to perform an algorithmic task using a machine learning training technique,
wherein the algorithmic task is specified by a computational algorithm defined by a set of rules that, when applied to a dataset, cause the dataset to be processed over a sequence of computational steps to generate an algorithmic output, and
wherein training the neural network comprises:
obtaining an input dataset;
generating a first augmented dataset and a second augmented dataset, wherein for both the first augmented dataset and the second augmented dataset:
applying the computational algorithm to the augmented dataset causes the same computational operations to be performed at a target computational step as would be performed by applying the computational algorithm to the input dataset;
processing the first augmented dataset and the second augmented dataset using the neural network, comprising, for each augmented dataset:
generating an intermediate representation of the augmented dataset at an intermediate layer of the neural network; and
training the neural network on an objective function, wherein the objective function comprises a self-supervised loss term that depends on: (i) the intermediate representation of the first augmented dataset generated at the intermediate layer of the neural network, and (ii) the intermediate representation of the second augmented dataset generated at the intermediate layer of the neural network.

20. One or more non-transitory computer storage media storing instructions that when executed by one or more computers cause the one or more computers to perform operations comprising:
training a neural network to perform an algorithmic task using a machine learning training technique,
wherein the algorithmic task is specified by a computational algorithm defined by a set of rules that, when applied to a dataset, cause the dataset to be processed over a sequence of computational steps to generate an algorithmic output, and
wherein training the neural network comprises:
obtaining an input dataset;
generating a first augmented dataset and a second augmented dataset, wherein for both the first augmented dataset and the second augmented dataset:
applying the computational algorithm to the augmented dataset causes the same computational operations to be performed at a target computational step as would be performed by applying the computational algorithm to the input dataset;
processing the first augmented dataset and the second augmented dataset using the neural network, comprising, for each augmented dataset:
generating an intermediate representation of the augmented dataset at an intermediate layer of the neural network; and
training the neural network on an objective function, wherein the objective function comprises a self-supervised loss term that depends on: (i) the intermediate representation of the first augmented dataset generated at the intermediate layer of the neural network, and (ii) the intermediate representation of the second augmented dataset generated at the intermediate layer of the neural network.
